(19) United States
(12) Patent Application Publication
(10) Pub. No.: US 2020/0058956 A1
(43) Pub. Date: Feb. 20, 2020

(54) Composite Reinforced Solid Electrolyte to Prevent Protrusions

(71) Applicant: Robert Bosch GmbH, Stuttgart (DE)

(72) Inventors: Nathan P. Craig, Santa Clara, CA (US); Giovanna Bucci, Santa Clara, CA (US)

(21) Appl. No.: 16/610,042

(22) PCT Filed: Aug. 10, 2018
(86) PCT No.: PCT/EP2018/071795

§ 371 Date: Oct. 31, 2019

Related U.S. Application Data
(60) Provisional application No. 62/547,155, filed on Aug. 18, 2017.

(51) Int. Cl. H01M 10/0562; H01M 4/36; H01M 4/38; H01M 4/48; H01M 10/052; H01M 10/054; H01M 10/0565; H01M 2/16

(52) U.S. Cl. CPC H01M 10/0562; H01M 4/364; H01M 4/382; H01M 4/386; H01M 4/483; H01M 10/052; H01M 2004/027; H01M 10/0565; H01M 2/1686; H01M 2/1606; H01M 2/1646; H01M 2/1653; H01M 10/054

(57) ABSTRACT

A solid composite battery separator is used to enable the use of a metal negative electrode in a battery. The metal negative electrode may be lithium metal, sodium metal, magnesium metal, zinc metal, or alloys of the metals listed. The composite separator includes a matrix and reinforcing material introduced into the matrix to increase fracture toughness of the composite separator. The composite separator comprises, either wholly or in part, a layer of reinforced polymer, ceramic or glassy lithium ion conductor. The matrix of the composite separator can include polyethylene oxide, LLZO, LiPON, or LATP. The reinforcing material of the composite separator can include fibers, particles, plates, or layers. The reinforcing material can include silicate glass, carbon nanotubes, silver nanowires, silicon carbide particles, and metallic particles.

### PRIORITY CLAIM

This application claims priority to U.S. provisional patent application No. 62/547,155, filed on Aug. 18, 2017 and entitled “Composite Reinforced Solid Electrolyte to Prevent Protrusions,” the disclosure of which is incorporated herein by reference in its entirety.

### TECHNICAL FIELD

This disclosure generally relates to batteries, and more particularly to solid state separators for batteries.

### BACKGROUND

Unless otherwise indicated herein, the materials described in this section are not prior art to the claims in this application and are not admitted to the prior art by inclusion in this section.

A battery utilizes a negative electrode, a positive electrode, and an electrolyte to convert chemical energy into electrical energy. Each of the negative electrode and the positive electrode includes an external terminal connection configured to connect the battery to an external device and deliver electric power to the external device. The electrolyte provides an ionic pathway between the negative electrode and the positive electrode within the battery. The electrolyte is conductive to ions but not conductive to electrons. When the battery is used to complete an electric circuit with an external device, the negative electrode acts as a source of electrons and the positive electrode accepts electrons as the battery is discharged. The electrolyte allows ions to transport current within the battery while the electrons flow through the external circuit. In solid state batteries, a solid material is used for the electrolyte. The solid material also acts to mechanically prevent contact between the negative electrode and positive electrode and may be referred to as a separator.

Batteries are being developed that utilize active metals or metal alloys as a negative electrode. A common metal of interest for the negative electrode is lithium metal. One advantage of batteries containing metal or metal alloy negative electrodes is the potential for increased energy density compared with state of the art lithium-ion batteries. However, one challenge is that the cells can short due to growth of metal protrusions from the negative electrode toward the positive electrode. Physical models have predicted that a flat separator with a shear modulus in excess of about 6 GPa should prevent the growth of lithium metal protrusions and enable the cycling of lithium metal. However, it has been observed that lithium protrusions grow through separators with shear modulus in excess of 6 GPa. It is believed that this growth occurs through cracks that propagate through brittle solid electrolytes.

### SUMMARY

A solid composite battery separator is used to enable the use of a metal negative electrode in batteries. The negative electrode may be lithium metal, sodium metal, magnesium metal, zinc metal, or alloys of the metals listed. The composite separator consists, either wholly or in part, of a layer of reinforced polymer, ceramic or glassy lithium ion conductor. Examples of suitable electrolytes include polyethylene oxide, LLZO, LiPON, or LATP. The reinforcement can include fibers, particles, or plates. Examples of suitable materials for reinforcement include silicate glass, carbon nanotubes, silver nanowires, silicon carbide particles, and metallic particles. The reinforcement is introduced to the brittle separator to increase fracture toughness and decrease growth of metal protrusions, thus enabling cycling of a cell containing a metal negative electrode without shorting. In addition to enabling the cycling of lithium metal batteries, the composite electrolyte can also be applied to other metal batteries; such as sodium, magnesium, or zinc, as well as alloy batteries such as lithium-silicon alloys.

### BRIEF DESCRIPTION OF THE DRAWINGS

FIG. 1 depicts a crack propagating in a brittle separator.

FIG. 2 depicts crack propagation impeded in a composite separator with rods of high tensile strength.

FIG. 3 depicts crack propagation impeded in a composite separator with particles of high ductility.

FIG. 4 depicts crack propagation impeded in a composite separator with particles of high fracture toughness.

FIG. 5 depicts crack propagation impeded in a composite separator with plates of high fracture toughness.

FIG. 6 depicts crack propagation impeded in a composite separator with plates of high ductility.

FIG. 7 depicts crack propagation impeded in a composite separator with layers of high ductility.

FIG. 8 depicts crack propagation impeded in a composite separator with layers of high fracture toughness.

### DETAILED DESCRIPTION

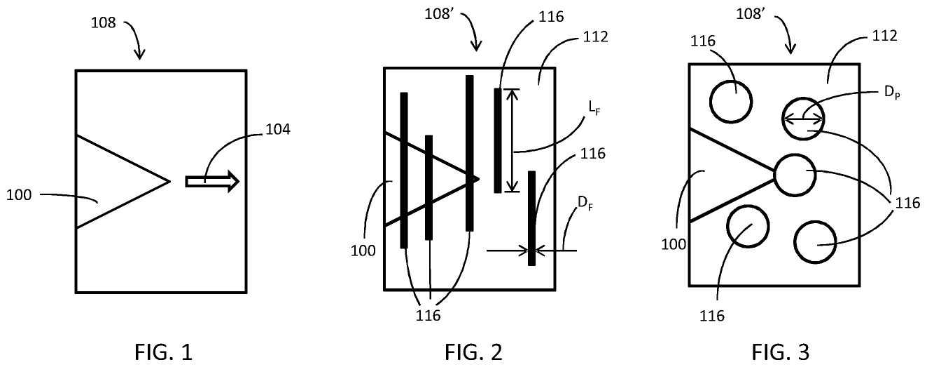

FIG. 1 depicts a crack 100 propagating in the direction of arrow 104 through a solid separator 108 of a battery (not shown). Propagation of the crack 100 through the separator 108 enables growth of lithium protrusions through the separator 108. Such growth is undesirable because it breaks down the separation between the anode and cathode in the battery, which can cause the battery to short.

To impede the propagation of the crack 100 through the separator 108, a composite electrolyte 108′, shown in FIGS. 2-8, has been developed. The composite electrolyte 108′ includes a matrix 112 and reinforcing material 116. The matrix 112 is made up of a solid lithium ion electrolyte, such as, for example, polyethylene oxide, LLZO, LiPON, LATP, Li2S-P2S5, Li3PS4, or any other solid lithium ion conductor. The reinforcing material 116 is introduced into the matrix 112 to increase the fracture toughness of the composite electrolyte 108′ by interfering with the propagation of cracks, including micro-cracks, in the composite electrolyte 108′.

In the embodiment shown in FIG. 2, the reinforcing material 116 is introduced into the matrix 112 as a plurality of rods, or fibers, with high tensile strength. The fibers can be made of, for example, at least one of silica glass, polystyrene, carbon nanotubes, silver nanowires, and other high tensile strength fibers. Each of the fibers has a diameter D_{F} that is less than 1 micron. Preferably, the diameter D_{F} of each of the fibers is less than 0.1 micron. In alternative embodiments, fibers having other diameters are also possible. Each of the fibers has a length L_{F} such that a length to diameter ratio of the fibers is greater than 2:1. Preferably, the length to diameter ratio is greater than 5:1. In alternative embodiments, fibers having other length to diameter ratios are also possible. Each of the fibers also has a tensile strength that is greater than a tensile strength of the matrix 112. Preferably, the tensile strength of each fiber is at least ten times the tensile strength of the matrix 112.

In the embodiment shown in FIG. 3, the reinforcing material 116 is introduced into the matrix 112 as a plurality of particles having high ductility. The particles can be made of, for example, at least one of silver, steel, copper, polypropylene, and lithium. Each of the particles has a diameter D_{P} that is less than 10 microns. Preferably, the diameter D_{P} of each of the particles is less than 1 micron. In alternative embodiments, particles having other diameters are also possible. Each of the particles also has a ductility that is greater than a ductility of the matrix 112. Preferably, the ductility of each particle is at least ten times the ductility of the matrix 112.

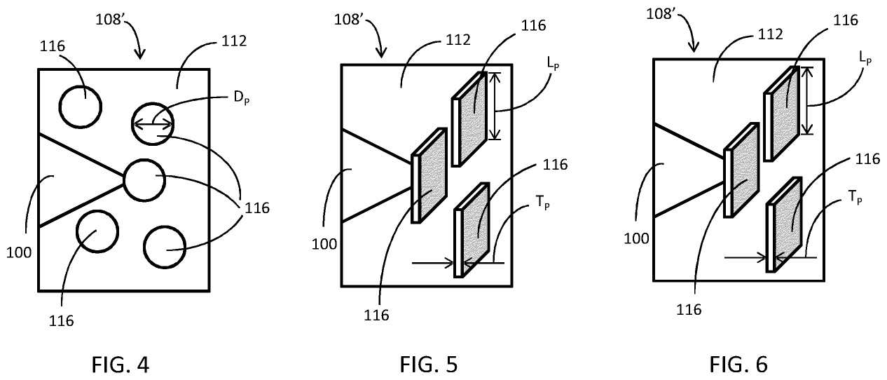

In the embodiment shown in FIG. 4, the reinforcing material 116 is introduced into the matrix 112 as a plurality of particles having high fracture toughness. The particles can be made of, for example, at least one of steel, titanium, aluminum, diamond, tungsten carbide, and silica. Like the particles having high ductility, shown in FIG. 3, each of the particles having high fracture toughness has a diameter D_{P} that is less than 10 microns. Preferably, the diameter D_{P} of each of the particles is less than 1 micron. In alternative embodiments, particles having other diameters are also possible. Each of the particles also has a fracture toughness that is greater than a fracture toughness of the matrix 112. Preferably, the fracture toughness of each particle is at least ten times the fracture toughness of the matrix 112.

In the embodiment shown in FIG. 5, the reinforcing material 116 is introduced into the matrix 112 as a plurality of plates having high fracture toughness. The plates can be made of, for example, at least one of steel, titanium, aluminum, diamond, tungsten carbide, and silica. Each of the plates has a thickness T_{P} that is less than 10 microns. Preferably, the thickness T_{P} of each plate is less than 1 micron. In alternative embodiments, plates having other thicknesses are also possible. Each of the plates has a greatest side length L_{P} such that a greatest side length to thickness ratio is greater than 2:1. Each of the plates also has a fracture toughness that is greater than a fracture toughness of the matrix 112. Preferably, the fracture toughness of each plate is at least ten times the fracture toughness of the matrix 112.

In the embodiment shown in FIG. 6, the reinforcing material 116 is introduced into the matrix 112 as a plurality of plates having high ductility. The plates can be made of, for example, at least one of silver, steel, copper, polypropylene, and lithium. Like the plates having a high fracture toughness, shown in FIG. 5, each of the plates having a high ductility has a thickness T_{P} that is less than 10 microns. Preferably, the thickness T_{P} of each plate is less than 1 micron. In alternative embodiments, plates having other thicknesses are also possible. Each of the plates has a greatest side length L_{P} such that a greatest side length to thickness ratio is greater than 2:1. Each of the plates also has a ductility that is greater than a ductility of the matrix 112. Preferably, the ductility of each plate is at least ten times the ductility of the matrix 112.

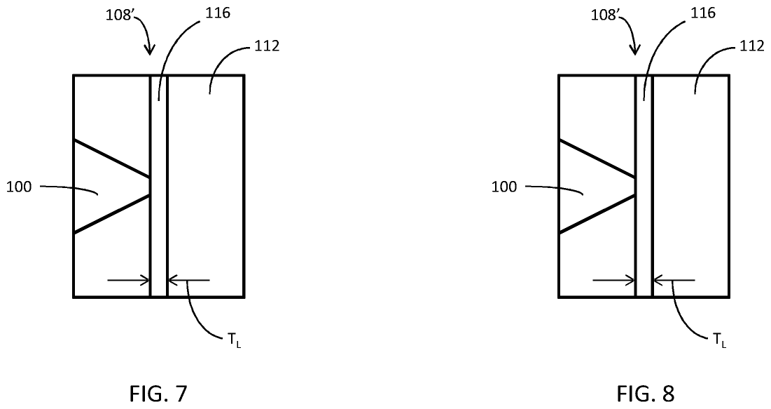

In the embodiment shown in FIG. 7, the reinforcing material 116 is introduced into the matrix 112 as at least one layer having high ductility. The at least one layer can be made of, for example, at least one of lithium metal, polyethylene oxide, lithium-silicon alloy, lithium-gold alloy, and lithium-tin alloy. The at least one layer has a thickness TL that is less than 100 microns. Preferably, the thickness TL of the at least one layer is less than 10 microns. In alternative embodiments, layers having other thicknesses are also possible. The at least one layer also has a ductility that is greater than a ductility of the matrix 112. Preferably, the ductility of the at least one layer is at least ten times the ductility of the matrix 112.

In the embodiment shown in FIG. 8, the reinforcing material 116 is introduced into the matrix 112 as at least one layer having high fracture toughness. The at least one layer can be made of, for example, at least one of LLZO, LLTO, LiPON, and LATP. Like the at least one layer having high ductility, shown in FIG. 7, the at least one layer having high fracture toughness has a thickness TL that is less than 100 microns. Preferably, the thickness TL of the at least one layer is less than 10 microns. In alternative embodiments, layers having other thicknesses are also possible. The at least one layer also has a fracture toughness that is greater than a fracture toughness of the matrix 112. Preferably, the fracture toughness of the at least one layer is at least ten times the fracture toughness of the matrix 112.

In alternative embodiments, the reinforcing material 116 can be introduced into the matrix 112 as a combination of two or more of fibers with high tensile strength (shown in FIG. 2), particles with high ductility (shown in FIG. 3), plates with high ductility (shown in FIG. 6), at least one layer with high ductility (shown in FIG. 7), particles with high fracture toughness (shown in FIG. 4), plates with high fracture toughness (shown in FIG. 5), and at least one layer with high fracture toughness (shown in FIG. 8).

In each of the embodiments shown in FIGS. 2-8, the reinforcing material 116 may or may not be electronically conductive. In each of the embodiments shown in FIGS. 2-6, the reinforcing material 116 may or may not be ionically conductive. In embodiments where the reinforcing material 116 is introduced as a layer, as shown in FIGS. 7 and 8, the layer should be ionically conductive to a degree greater than 10⁻⁸ S/cm. Preferably, the layer should be ionically conductive to a degree greater than 10⁻⁶ S/cm.

In each of the embodiments shown in FIGS. 2-8, loading of the reinforcing material 116 in the composite electrolyte 108′ should be less than 50% by volume. Preferably, loading of the reinforcing material 116 in the composite electrolyte 108′ should be less than 20% by volume. Ideally, loading of the reinforcing material 116 in the composite electrolyte 108′ should be less than 10% by volume.

While various embodiments of the present disclosure have been shown and described, it will be understood that other modifications, substitutions, and alternatives are apparent to one of ordinary skill in the art. Such modifications, substitutions, and alternatives can be made without departing from the spirit and scope of the disclosure.

What is claimed is:

1. A composite electrolyte for use in a battery, the composite electrolyte comprising:
a matrix; and
a reinforcing material introduced into the matrix, the reinforcing material configured to increase a fracture toughness of the composite electrolyte.

2. The composite electrolyte of claim 1, wherein:
the reinforcing material includes a plurality of fibers, each of the fibers having a tensile strength that is greater than a tensile strength of the matrix.

3. The composite electrolyte of claim 1, wherein:
the reinforcing material includes a plurality of particles, each of the particles having a ductility that is greater than a ductility of the matrix.

4. The composite electrolyte of claim 1, wherein:
the reinforcing material includes a plurality of particles, each of the particles having a fracture toughness that is greater than a fracture toughness of the matrix.

5. The composite electrolyte of claim 1, wherein:
the reinforcing material includes a plurality of plates, each of the plates having a ductility that is great than a ductility of the matrix.

6. The composite electrolyte of claim 1, wherein:
the reinforcing material includes a plurality of plates, each of the plates having a fracture toughness that is greater than a fracture toughness of the matrix.

7. The composite electrolyte of claim 1, wherein:
the reinforcing material includes at least one layer, the at least one layer having a ductility that is greater than a ductility of the matrix.

8. The composite electrolyte of claim 1, wherein:
the reinforcing material includes at least one layer, the at least one layer having a fracture toughness that is greater than a fracture toughness of the matrix.

9. A battery, comprising:
an anode made of one of lithium metal, magnesium metal, sodium metal, silicon, and silicon oxide;
a cathode; and
an electrolyte separating the anode from the cathode, the electrolyte arranged in contact with the anode.

10. The battery of claim 9, wherein:
the electrolyte is a composite electrolyte, including:
a matrix; and
a reinforcing material introduced into the matrix, the reinforcing material configured to increase a fracture toughness of the composite electrolyte.

11. The battery of claim 9, wherein:
the reinforcing material includes a plurality of fibers, each of the fibers having a tensile strength that is greater than a tensile strength of the matrix.

12. The battery of claim 9, wherein:
the reinforcing material includes a plurality of particles, each of the particles having a ductility that is greater than a ductility of the matrix.

13. The battery of claim 9, wherein:
the reinforcing material includes a plurality of particles, each of the particles having a fracture toughness that is greater than a fracture toughness of the matrix.

14. The battery of claim 9, wherein:
the reinforcing material includes a plurality of plates, each of the plates having a ductility that is great than a ductility of the matrix.

15. The battery of claim 9, wherein:
the reinforcing material includes a plurality of plates, each of the plates having a fracture toughness that is greater than a fracture toughness of the matrix.

16. The battery of claim 9, wherein:
the reinforcing material includes at least one layer, the at least one layer having a ductility that is greater than a ductility of the matrix.

17. The battery of claim 9, wherein:
the reinforcing material includes at least one layer, the at least one layer having a fracture toughness that is greater than a fracture toughness of the matrix.
